(19) United States
(12) Patent Application Publication
(10) Pub. No.: US 2011/0068690 A1
(43) Pub. Date: Mar. 24, 2011

(54) Plasma jet guard

(76) Inventor: Bereli M. Lazar, San Francisco, CA (US)

(21) Appl. No.: 12/586,378

(22) Filed: Sep. 22, 2009

(51) Int. Cl. H01J 7/00

(52) U.S. Cl. 315/111.21

(57) ABSTRACT

The system includes a method and means of technological defense against violent atmospheric cyclones: tornadoes, hurricanes, others. The controlled meteorological missiles equipped with rocket servo-motors and magneto-gas-dynamic ionizers are used.

The running out hot exhaust gases of rocket motors are converted into electro-conductive dashed plasma jets, which initiate and trigger multiple electro-shorting dischargers between contrary charged zones through ionized plasma jet segments of said dischargers.

This disorders and de-energizes the cyclonic electrically saturated zones by multiple triple diverse and combined actions. The rotations slow down and end, and the cyclones get dispersed by own winds.

The Guard can be used for preventing violent sky cyclones and severe lightning storms by preemptive operating into monitored over-saturated atmospheric electrostatic fields.

### RELATED APPLICATION

Patent Ser. No. 11/416,600, filed May 4, 2006, and then titled as “Challenger to . . . twisters”; amendments A, B, C, D, E, F to said above Ser. No. 11/416,600, which was abandoned by Office Action (OA) of Jul. 23, 2009 in view of failure to timely file a proper reply to the OA of Apr. 27, 2009.

### FEDERALLY SPONSORED RESEARCH

Not applicable.

### SEQUENCE LISTING OR PROGRAM

Not applicable.

### TECHNICAL FIELD

This proposal relates to the methods and means of technological defense against severe atmospheric cyclonic forms such as tornadoes, hurricanes, and others all named here as cyclones.

The proposal deals with:
gas—dynamic ionized electro-conductive plasma jets,
electro-magnetic inductive ionizing converters for hot gas jets,
atmospheric electricity and its discharges,
controlled meteorological missiles (further—CMM),
rocket motors (further RM) and their exhausts, and
electro-mechanical and navigation infrastructures.

More then 550 tornadoes and hurricanes attack America every year. The usual monitoring, predictions, and warnings are definitely deficient.

Numerous reports, references, books, articles, and experiments—including enacted myself with mini-twisters, so called “smerches”, —clearly indicate:
a) Sky cyclones shaped up in saturated electro-static fields of high intensity about E=100 kw/m, i.e. in very powerful zones;
b) Most of sky cyclones are naturally formed and self-tuned combined rotary electrical machines like enormous specific motor-generators working in common volumes of involved atmospheric charges; being in united structure, cyclone—motor and cyclone—generator substructures power, drive, and boost each other, rotating and amplifying together;
c) This electric phenomenon is uniquely combined with thermodynamic, electro-magnetic, inductive, heat—convection, and ionization phenomena, also with affections of water-evaporations, solar radiation, and winds;
d) The sky cyclones accumulate their energy with electrostatic charging of huge masses of air and vapor particles at large areas of tense friction and mutual induction in natural magnetic and electro-magnetic fields.

Said electro-static, magnetic, thermal, and other interactions are clearly described in the book “The Electrical Nature of Storms” (Oxford University Press, NY; QC 961 M18. 1998) by D. R. Mac Gorman and W. D. Rust (both present the National Severe Storms Laboratory; Norman, Okla., USA).

My proposal suggests a method and means for technological and ecologically pure defense against sky cyclones, disordering and de-energizing their self-tuned power structures with electro-shorting dischargers between opposite-charged atmospheric zones through ionized electro-conductive plasma jets inside and near the formed or forming up cyclones. Said jets are prepared aboard CMM for operating the multiple triple actions which force the sky cyclones to loose their power and self-disperse out.

Any Prior Arts directly connected to present proposal were not found.

### BRIEF SUMMARY OF THE INVENTION

The substance and key objects of this proposal are:
1. A method and means for disordering power structures and self-tuned mechanisms of electrification of the sky cyclones, de-energizing their driving electric fields, to strike onto thermodynamic and electro-magnetic state and mechanical momentum of cyclones' rotating masses.
2. Usage of hot gas exhausts of servo rocket motors as technological instruments which are delivered to the cyclones by equipped CMMs.
3. Magneto-gas-dynamic inductive converting of running out exhausts of said RM into ionized electro-conductive plasma jets aboard said CMMs by magneto-gas-dynamic jet (further—MJ) ionizers.
4. Triggering multiple electro-shorting dischargers between contrary-charged cyclonic flows and cyclones' anvils through said plasma jets as artificial lightning bolts, each operating triple actions: electro-shorting discharges, thermal and electro-magnetic strikes, and mechanical shock-waves.
5. Usage of CMMs equipped with thrust rocket motors, electro-generators, electrometers, other devices, —for proper navigation and protected flights near and inside cyclones, and also at different altitudes—for two CMMs.
6. Usage of seeded rocket fuels in order to obtain better electro-conductivity for ionized plasma jets converted from running out rocket exhausts.
7. To have a possibility of preventing severe cyclones and lightning storms by preemptive operating to monitored zones of over-saturated sky electricity.

### DRAWING FIGURES

In the drawings, closely related units and elements have the same numbers, but different alphabetic suffixes. The numbers of views, sections, and fragments correspond to the numbers of figures where they are shown.

FIGS. 6 and 6A, fragment 7 of FIG. 5 and FIG. 7A are related respectively.

FIG. 1 shows a sectional plan view of a basic Plasma Jet Guard in operative flight.

FIG. 2 illustrates a sectional plan view of a boosted embodiment of the Plasma Jet Guard in its operative flight.

FIG. 3 shows the cross-section view taken in FIG. 1.

FIG. 4 is a basic general scheme of MJ ionizers developed in present proposal.

FIG. 5 is a typical scanned tech-electrical scheme of the Guard including the MJ ionizer shown in FIG. 4, and illustrating all the functional process.

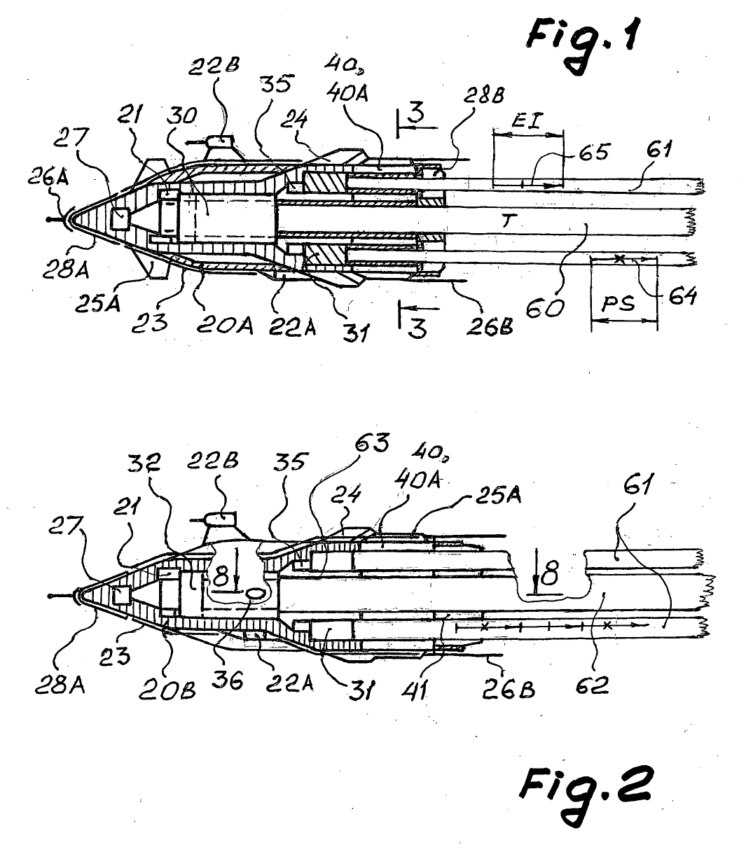

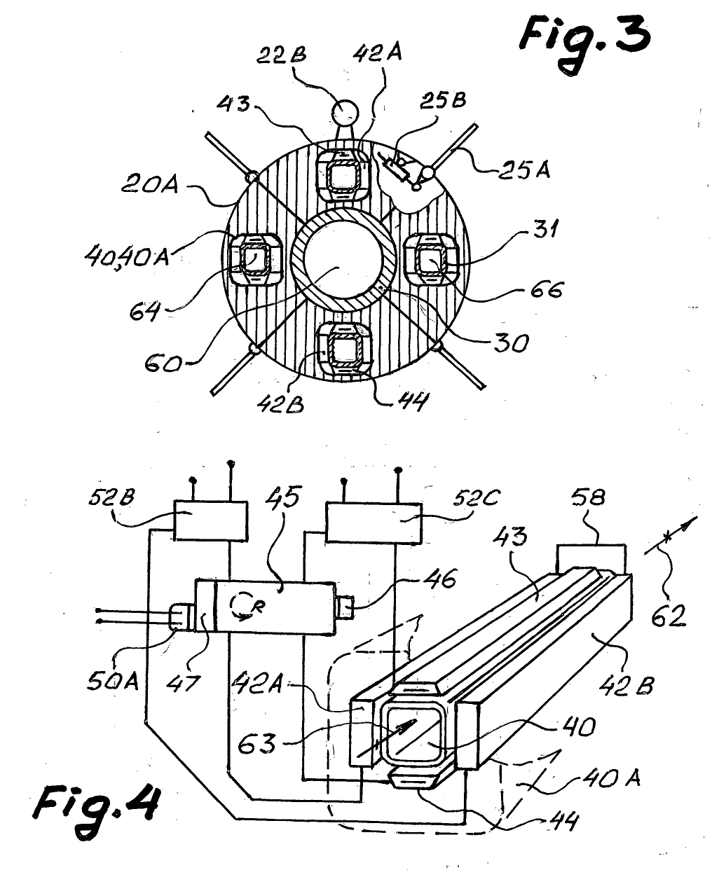

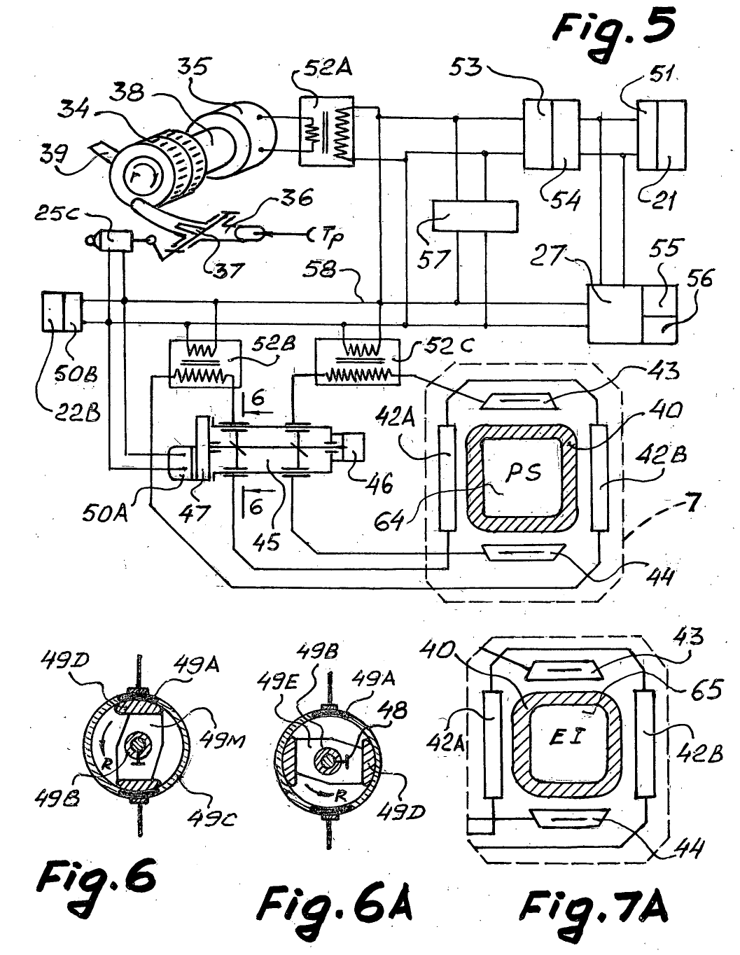

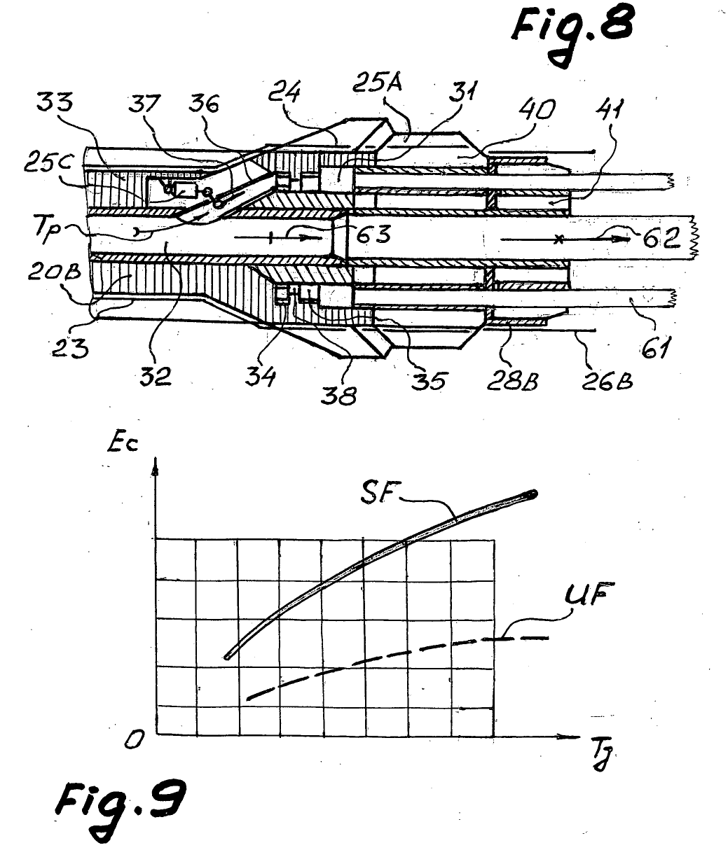

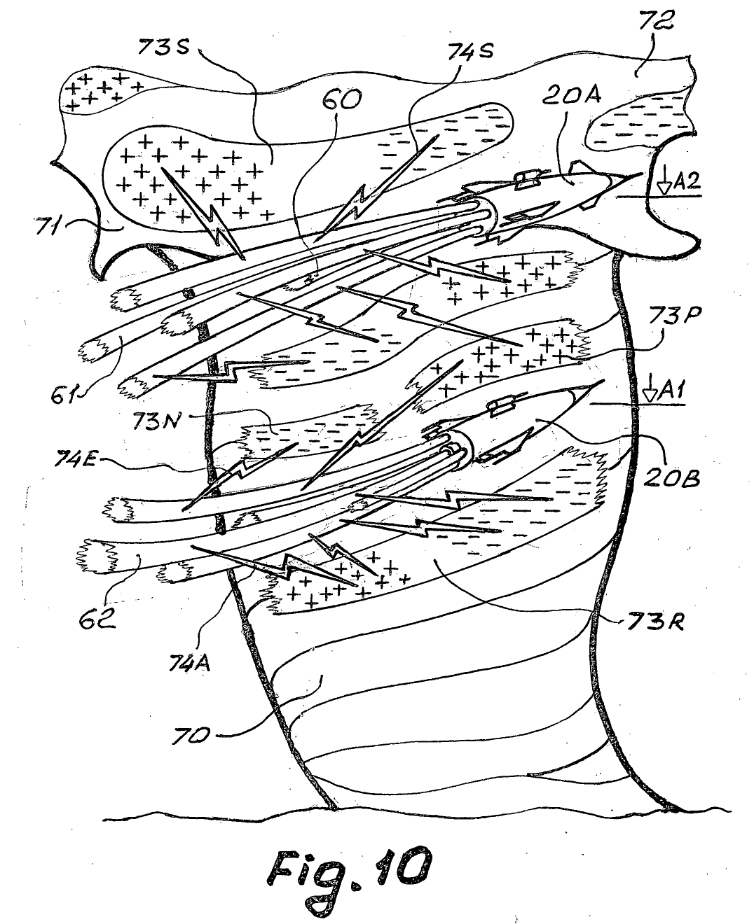

FIG. 6 shows both sections 6-6 taken in FIG. 5 for closed electric circuits.

FIG. 6A shows said sections of FIG. 6, but for disconnected electric circuits.

FIG. 7A is a fragment 7 of FIG. 5, but shown for FIG. 6A where current I=0.

FIG. 8 is a partial section taken in FIG. 2.

FIG. 9 shows graph-curves of electro-conductivities for ionized jet plasmas obtained in MJ ionizer from seeded and unseeded rocket fuel exhausts.

FIG. 10 is a space scheme of two GUARDs guided to different altitudes of an example tornado in coordinated functional cooperation.

### REFERENCE NUMERALS, CHARACTERS, SYMBOLS in DRAWINGS

Guard numerals. A. Controlled Meteorological Missiles (CMM): 20A—Basic CMM 20B—Plasma-boosted CMM 21—Electric block 22A,22B—Electro-meters 23—Electro-insulation 24—Flapped winglet 25A—Rudder, Fin 25B, 25C—Servomechanisms 26A, 26B—Self-detachable lightning rods 27—Control block 28A, 28B—Nose, tail protectors. B. Rocket motors (RM): 30—Thrust RM 31—Plasma jet servo-RM 32—Combined RM 33—Thermo-insulation 34—Turbine 35—Electro-generator 36—Exhaust branch 37—Damper 38—Adjuster 39—Turbine outlet. C. Magneto-gas-dynamic jet (MJ) ionizer: 40—Basic MJ ionizer 40A—Casing 41—Thrust MJ ionizer 42A, 42B—Electro-magnet legs 43—Anode electrode 44—Cathode electrode 45—Contactor 46—Rotor's meter 47—Drive adjuster 48—Fixer 49A—Static tie 49B—Rotor 49C—Stator 49D—Rotor's tie 49E, 49M—Electrodes' and Magnets' Cams, respectively. D. Universal units, devices, and structures: 50A, B—Electric motors 51—Battery 52A,B,C—Electric transformers 53—Rectifier 54—Electro-charger 55—Navigation block 56—Sensor block 57—Electric RLC-oscillator 58—Wiring.

Jets' numerals, characters, and symbols. 60; T—Thrust jet 61—Dashed plasma jet 62—Combined jet 63—Exhaust jet 64; PS—Plasma segment 65; EI—Exhaust jet interval

Cyclonic and operative numerals, and symbols: 70—Tornado funnel 71—Tornado collar 72—Upper cloud 73N—Negatively charged spin-flow 73P—Positively charged spin-flow 73S—Static round-up charged anvil 73R—Round-up charged spin-flow 74A, E, S—Intra-flow, Inter-flow, and Static anvil Dischargers, respectively A 1, A2—Operative altitudes R—Rotation Tp—Exhaust portion

Most of regular conventional units. structures, and elements have their particularities connected with function operations of the Guards' systems.

Those, mentioned above, are not considered in present proposal as New Matter and are not subjects of following detailed description.

Well known subunits, communications, infrastructures, guidance, general service structures and devices like parachute-unit, other controls are not shown in drawings for better clarity and reasonable shortness.

### DETAILED DESCRIPTION, GENERAL OPERATION

The Plasma Jet Guard is a technological instrument for defense against severe atmospheric cyclones like tornadoes, hurricanes, others. The Guard includes a controlled meteorological missile [CMM] with a trust and plasma-jet servo rocket motors [RM], guidance electrometers, magneto-gas-dynamic jet [MJ] ionizers, and interacting devices, all shown in their operations on drawing figures.

FIG. 1 illustrates a typical embodiment of the Guard which includes a basic CMM 20A, thrust RM 30, plasma-jet servo-RMs 31, basic MPJ ionizers 40, and other mentioned in reference list elements. The operative thrust jet 60, and dashed plasma jets 61 are shown.

FIG. 2 shows another, more boosted embodiment of the Guard which includes plasma-boosted CMM 20B, combined RM 32, trust MJ ionizer 41. The inlet of exhaust branch 36 for board electro-generator 35 driving, thrust MJ ionizer 41, and dashed thrust-plasma combined jet 62 are shown.

FIG. 3 shows a preferable symmetrical and balanced arrangements of plasma-jet servo-RMs 31 with connected to them MJ ionizers 40 what is important for stable controlled flights in severe storm conditions.

FIG. 4 illustrates a general scheme of a Basic MJ ionizer 40. Are shown electromagnet legs 42A, 42B; electrodes 43, 44; transformers 52B, 52C, contactor 45, coming exhaust jet 63, converted with said magnets 42A, 42B into ionized dashed plasma jet 61, other indicated elements.

FIG. 5 displays the general scheme of the Guard in operation. All the elements are indicated in reference numerals section. The state of the basic ionizer 40, shown in fragment 7, corresponds to the closed electric chain provided by rotating contactor 45 for obtaining plasma jet segment 64 in shown here instant, as a step of said above dashed plasma jet 61.

FIGS. 6 and 6A show how the contactor 45 closes and disconnects electrical feeding of ionizer 40, providing current I or not, respectively. The common metered and adjusted rotation R of cams 49M and 49E coordinates the order of ionizer's 40 units work, as well as adjusting of shown on FIG. 5 transformers 52 A,B,C and RLC-oscillator 57.

FIG. 7A shows the fragment 7, but operatively corresponds to FIG. 6A, when ionizer's 40 electromagnet legs 42A, 42B and electrodes 43 and 44 are disconnected for exhaust non-ionized interval 65 or thrust jet 63.

FIG. 8 illustrates how the portion Tp of running out exhausts 63 of the combined RM 32 is taken off for turbine 34 driving. All the previously mentioned elements are shown in operation.

FIG. 9 shows the ionizing benefits of seeded rocket fuels for plasma jet RM 31,32. The electro-conductivity Ec of obtained plasmas for the same exhaust temperatures Tj is much higher for seeded fuels SF, than for unseeded rocket fuels UF; the electro-shorting dischargers 74 become much stronger. Seed materials: alkali-metallic powder. cesium, and potassium, depending on rocket propellant and MJ ionizers' 40, 41 arrangements, which are inductively similar to the known MHD-generators.
A. Said MHD-generators produce electricity by electro-magnetic induction of circularly moving hot gases; their electrodes deliver electric power from induced in magnetic field plasma to the electrical loads;
B. MJ ionizers 40, 41 inductively convert the hot rocket exhausts 63 into electro-conductive plasmas 62 for external electro-shorting. Ionizers' electrodes 43,44 start and boost the exhausts' conversion into electro-conductive plasmas, consuming energy from transformers 52 B,C.

FIG. 10 shows a scheme of action for two CMMs 20A, 20B near an exemplary tornado 70, 71. The missiles work at their altitudes A2 and A1, respectively. Multiple electro-shorting dischargers 74 A,E,S are triggered off between contrary charged zones in the spin-flows 73 N,P,R and in the anvil 73S through ionized electro-conductive plasma jets 62 and 64.

The exhaust jet intervals 65, being non-electro-conductive, protect both missiles 20A and 20B against possible back electro-strokes.

### Operative Interactions

The blocks 21, 27 with meters 22A,B provide needed guidance and maneuvers in order to reach atmospheric electricity saturated zones and start plasma jet RMs 31,32 and MRJ ionizers 40, 41 to work.

Said ionizers convert the hot running out exhaust gases of said RMs into ionized plasma jets 61,62 with correct adjusted electro-conductivity Ec to initiate and trigger multiple electro-shorting dischargers 74 between the contrary charged zones of atmospheric electricity through plasma segments.

The temperature of the air along the dischargers 74 lightning paths is suddenly risen up to about 54,000 F. This causes air pressure around stroke to rise instantly up to many hundred PSI, and air rapidly expands. The dynamic expansion of air creates multiple powerful thunder-shock waves around any of dischargers 74A, 74E, 74S, thus also mechanically disordering cyclones' rotating structures.

Each of dischargers 74, consisting of a leader and several return strokes, operates multiple triple actions onto sky cyclones:
a) electro-shorting between contrary charged zones of atmospheric electricity through plasma jet segments for effective discharging and disordering the cyclones' self-tuned powerful electrical structures;
b) thermal and electromagnetic strikes generated by instant conversions for messing and destroying the thermo-electric states of the cyclones;
c) dynamic mechanical shocks for rotating and moving zones affection.

Said multiple triple actions of many dischargers 74 lead to disordering, disorganizing, and de-energizing the self-tuned powerful structures of saturated electric fields, which drove sky cyclones. Step by step, the sky cyclones self-disperse, mostly by the winds which moved them.

The missiles 20A, 20B return back with gentle parachute landings for recovery and preparing to the next missions.

The Plasma Jet Guard and the method can be used for preventing violent sky cyclones and severe lightning storms by operating said prepared missiles into monitored zones of measured voltage over-accumulation for discharging and de-energizing the high-saturated atmospheric electricity.

1. A Plasma Jet Guard for defense against violent atmospheric cyclones, and consisting of a controlled meteorological missile equipped with a trust rocket motor, electrometers, a control block, electro-insulation, guidance, an operative turbo-electro-generator, detachable protectors with lightning rods, and a flight infrastructure, comprising at least one servo rocket motor compounded with a magneto-gas-dynamic jet ionizer for inductive converting the running out hot exhaust gases of said servo rocket motor into electro-conductive plasma-jets.

2. The Plasma Jet Guard of claim 1 wherein said magneto-gas-dynamic jet ionizer consisting of anode and cathode electrodes for jet ionization starting and boosting, and electromagnets for inductive conversion, comprises a rotating contactor for said plasma-jets dashed embodiments and operative regulations of ionizer's feeding electric chains.

3. The Guard of claim 1 wherein said thrust rocket motor can include:
a) an integrated said servo-rocket motor operating combined thrust-plasma jets for boosted Guards, based on fuels seeded with metallic powder for better ionization, higher electro-conductivity of produced plasma jets,
b) an exhaust branch, a controlled damper for said turbo-electro-generator driving by a portion of motor's exhaust gases.

4. The Plasma Jet Guard of claim 1 comprises a method of Technological Defense against atmospheric violent cyclones by said ionized electro-conductive plasma jets which trigger multiple triple actions:
a) electro-shorting dischargers between contrary-charged cyclonic zones through ionized electro-conductive plasma jets thus de-energizing the electrically saturated powerful structures of cyclones,
b) thermal and electromagnetic strikes generated around said electro-shorting dischargers by instant conversions, messing, and destroying the thermo-electrical state of the affected charged particles,
c) mechanical pressure-shock waves around said shorting dischargers caused by dynamic affections of instant thermo-strikes;

5. The method of claim 4 wherein said electro-shorting dischargers with their combined triple actions disorder and de-energize cyclones and force them to stop rotations and be dispersed by own winds.

6. The method of claim 4 wherein said plasma jets are performed preferably dashed, with adjacent plasma-segments and non-ionized exhaust-intervals to protect the missile from possible back discharge-strikes.

7. The method of claim 4 wherein the Plasma Jet Guard can be used for preventing violent cyclones and severe lightning storms by operating said Guards into monitored atmospheric zones of measured extremely saturated static electricity for discharging and de-energizing the recorded sky voltage over-accumulations.
